(19) United States
(12) Patent Application Publication
(10) Pub. No.: US 2003/0108449 A1
(43) Pub. Date: Jun. 12, 2003

(54) Ultraphobic surface structure having a plurality of hydrophilic areas

(76) Inventors: Karsten Reihs, Koln (DE); Wolfgang Paffhausen, Leverkusen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/182,722

(22) PCT Filed: Jan. 29, 2001
(86) PCT No.: PCT/EP01/00906

(30) Foreign Application Priority Data
Feb. 9, 2000 (DE) 100 05 600.8

(51) Int. Cl. B01L 3/00

(52) U.S. Cl. 422/99; 422/102

(57) ABSTRACT

Disclosed is an ultraphobic surface structure, especially a microtitre plate and a method for the production thereof which is provided with a plurality of hydrophilic areas which are preferably distributed on the surface in a periodic manner.

Ultraphobic surface structure having a plurality of hydrophilic areas The invention concerns a surface structure with an ultraphobic surface, in particular a microtitre plate and a method for the production thereof, which is structured with a plurality of hydrophilic areas which are preferably distributed on the surface in a periodic manner. The invention also concerns the use of the surface structure as a microtitre plate or printing plate.

In the field of medicinal chemistry and also of biology it is nowadays increasingly necessary to perform series tests. Here, for example, a large number of extremely small liquid test volumes are mixed with different active ingredients in order to test the reaction of the liquid to the active ingredient in question.

Tests of this kind are performed on so-called microtitre plates. Microtitre plates are plates which have a plurality of small indentations at regular intervals, e.g. 2 mm, into which the liquid is introduced. Microtitre plates of this kind are produced by extrusion or injection moulding. However, these procedures are expensive and have a high scrap rate. As microtitre plates are single-use items, currently a relatively large amount of waste occurs which has to be disposed of.

Therefore, the object is set of providing a microtitre plate which does not have the above-mentioned drawbacks and during the production of which less waste is produced.

According to the invention, the object is achieved by the provision of a flat structure which also has ultrahydrophobic and selectively hydrophilic areas.

The object of the invention is a flat structure, in particular a plate, particularly preferably a microtitre plate, with a surface with ultraphobic properties, characterised in that the flat structure is structured with a plurality of hydrophilic areas.

A surface structure of this type may be a part of any moulded article. However, preferably the surface structure is a particularly flat plate.

Hydrophilic areas within the meaning of the invention are areas on which a water droplet with a size of 10 μl takes on a contact angle of <90° and the roll-off angle of the water droplet with the above-mentioned volume exceeds 10°.

Ultrahydrophobic areas for the purpose of the invention are characterised by the fact that they have an ultrahydrophobic surface on which the contact angle of a droplet of a liquid lying on the surface is significantly more than 120°C., in good cases close to 180° and the roll-off angle does not exceed 10°.

Advantageously, the hydrophilic areas are arranged on the surface so they are enclosed by the ultrahydrophobic areas.

Also preferably, the hydrophilic areas only represent a small part of the overall surface.

Advantageously, the hydrophilic areas are arranged uniformly on the surface so that a certain pattern is produced.

Preferred is a surface structure in which the hydrophilic areas are partially or completely distributed on the surface in a periodic manner.

Particularly preferably, the hydrophilic areas distributed on the surface in a periodic manner have the same surface shape.

In a particularly preferred embodiment, the surface shape of the individual hydrophilic areas is rectangular or circular.

Here, the surface area of the individual hydrophilic areas is particularly preferably from 1 nm² to 1 μm².

Preferably, the hydrophilic areas are partially or completely distributed on the surface of the surface structure so they form an image and/or character pattern.

Suitable known ultrahydrophobic surfaces have been disclosed, for example, in the publications WO 98/23549, WO 96/04123, WO96/21523 and WO 96/34697, which are introduced here as references and hence count as part of the disclosure.

In a preferred embodiment, the ultraphobic surface has a surface topography in which the value of the integral of the function S(log f)=a(f)·f, which gives a relationship between the spatial frequencies of the individual Fourier components and their amplitudes a(f), is between the integration limits log(f₁/μm⁻¹)=−3 and log (f₂/μm⁻¹)=3, at least 0.5, in particular 0.6 and consists of an ultraphobic material or a material which has been rendered durably ultraphobic. An ultraphobic surface of this kind is described in the unpublished German patent application with the file number 19860136.0.

In a preferred variant, the ultraphobic surface of the surface structure is an aluminium surface, which is possibly anodically oxidised, treated with hot water or steam, possibly coated with a layer of adhesion promoter as described in the unpublished German patent application with the file reference 19860138.7.

Here, the surface structure may in particular be entirely produced from aluminium or preferably have an aluminium lining, with the surface of the aluminium being treated as described above.

In another preferred variant of the surface structure according to the invention, the ultraphobic surface is a surface which is coated with Ni(OH)₂ particles, possibly coated with an adhesion promoter and then provided with a hydrophobic coating compound, as described in the unpublished German patent application with the file reference 19860139.5.

Preferably, the Ni(OH)₂ particles have a diameter d₅₀ of from 0.5 to 20 μm.

In another advantageous embodiment of the invention, the ultraphobic surface is constructed from wolfram carbide, which is structured with a laser, possibly coated with an adhesion promoter and then provided with a hydrophobic coating compound, as described in the unpublished German patent application with the file reference 19860135.2.

Preferably, the surface structure is only coated with wolfram carbide, which is then treated as described above. Particularly preferably, the wolfram carbide layer has a layer thickness of from 10 to 500 μm.

In another variant, the ultraphobic surface of the surface structure may be created in that the surface of the surface structure is sandblasted with a blasting agent, possibly coated with a layer of adhesion promoter and then provided with a hydrophobic coating compound as described in the unpublished German patent application with the file reference 19860140.9.

Suitable as ultrahydrophobic or oleophobic coverings are all surface active hydrophobing agents with any molar masses.

Suitable as hydrophobing agents are all surface active substances with any molar masses. These compounds are preferably cationic, anionic, amphoteric or non-ionic surface-active compounds, such as those listed in the directory “Surfactants Europa, A Dictionary of Surface Active Agents available in Europe, Edited by Gordon L. Hollis, Royal Society of Chemistry, Cambridge, 1995”, for example.

Examples of anionic hydrophobing agents are: alkyl sulfates, ether sulfates, ether carboxylates, phosphate esters, sulfosuccinates, sulfosuccinate amides, paraffin sulfonates, olefin sulfonates, sarcosinates, isothionates, taurates and lignin compounds.

Examples of cationic hydrophobing agents are quaternary alkyl ammonium compounds and imidazoles.

Examples of amphoteric hydrophobing agents are betaines, glycinates, propionates and imidazoles.

Examples of non-ionic hydrophobing agents are: alkoxylates, alkylamides, esters, amine oxides and alkylpolyglycosides. Also eligible are: conversion products of alkylene oxides with alkylatable compounds, such as, for example, fatty alcohols, fatty amines, fatty acids, phenols, alkylphenols, aryl alkylphenols, such as styrene-phenol condensates, carboxylic acid amides and resin acids.

Particularly preferred are hydrophobing agents in which 1 to 100%, particularly preferably 60 to 95% of the hydrogen atoms are substituted by fluorine atoms. Examples mentioned are perfluorinated alkyl sulfate, perfluorinated alkyl sulfonates, perfluorinated alkyl phosphates, perfluorinated alkyl phosphinates and perfluorinated carboxylic acids.

Preferably, compounds with a molar mass M_{W} of >500 W to 1,000,000, preferably 1,000 to 500,000 and particularly preferably 1,500 to 20,000 are used as polymer hydrophobing agents for the hydrophobic coating or as polymer hydrophobic material for the surface. These polymer hydrophobing agents may be non-ionic, anionic, cationic or amphoteric compounds. In addition, these polymer hydrophobing, agents may be homo- and copolymers, graft polymers and graft copolymers and statistical block polymers.

Particularly preferred polymeric hydrophobing agents are those of the AB-, BAB- and ABC block copolymer types. In the AB, or BAB block polymers, the A segment is a hydrophilic homopolymer or copolymer and the B-block a hydrophobic homopolymer or copolymer or a salt thereof.

Particularly preferred are also anionic, polymeric hydrophobing agents, in particular condensation products or aromatic sulfonic acids with formaldehyde and alkylnaphthaline sulfonic acids or from formaldehyde, naphthaline sulfonic acids and/or benzene sulfonic acids, condensation products from possibly substituted phenol with formaldehyde and sodium bisulfite.

Also preferred are condensation products which may be obtained by the conversion of naphthalene with alkanols, additions of alkylene oxide and at least partial conversion of the terminal hydroxy groups into sulfo groups or semi-esters of maleic acid and phthalic acid or succinic acid.

In another preferred embodiment, the hydrophobing agent comes from the group of sulfosuccinic acid esters and alkyl benzene sulfonates. Also preferred are sulphated, alkoxylated fatty acids or their salts. Alkoxylated fatty acid alcohols should be understood to mean C₆-C₂₂ fatty acids, in particular those with 5 to 20, with 6 to 60, most preferably with 7 to 30 ethylene oxide units which are saturated or unsaturated, in particular stearyl alcohol. The sulphated alkoxylated fatty acid alcohols preferably occur as salts, in particular as alkali or amine salts, preferably as diethylamine salts.

The surfaces according to the invention are advantageously produced in that a surface structure with an ultraphobic surface is destroyed and hydrophilised locally at the points at which the surface should be hydrophilic.

The surface according to the invention may be used in all areas in which it is desirable for water or water-containing substances only partially to wet a surface. The surface structure may be used particularly advantageously as a printing plate or a microtitre plate.

If the surface structure is used as a printing plate, the ultrahydrophobic layer of the surface is selectively destroyed and hydrophilised in the areas in which the printing ink is to adhere.

If the surface is used as microtitre plate, the ultrahydrophobic layer is destroyed in a plurality of places. These places have, for example, an area of the order of magnitude of from 1 nm² to 1 μm² and are preferably arranged at regular distances of a few mm from each other.

A microtitre plate of this type has the following advantages:

the volume of the water droplets may be easily monitored by measuring the diameter of the spherical droplets

the production of the microtitre plate is simpler than it is in the prior art. In this example, the laser structuring may also be very easily integrated in the automatic metering units.

the microtitre plates may be sold in the form of simple films, which the customer may use flexibly in a suitable grating and a suitable field size.

The test volumes are freely accessible drops which may be approached and scanned with detection devices.

The drop volumes may be easily reduced to the range of 1 nl. This enables the surface density to be clearly increased compared to conventional microtitre plates.

the amount of material required to produce a microtitre plate is less than that in prior art. Less waste is produced after the use of this single-use article.

The surface structure according to the invention is simple and inexpensive to produce. It may, for example, be produced as a film and bonded to any moulded article as a substrate. Consequently, the film may be sold as a microtitre plate, with after its use, only the film, and not the entire moulded article to which it was applied, having to be disposed of.

Another subject of the invention is the use of the surface structure according to the invention as a printing plate, in particular for black-white printing or multi-coloured printing.

The subject of the invention is also the use of the surface structure as a microtitre plate.

Another subject of the invention is a procedure for the production of a surface structure according to the invention by the selective removal of an ultraphobic surface layer on a hydrophilic substrate at the places which are to form hydrophilic areas, in particular by mechanical or chemical stripping, in particular by laser radiation of a suitable intensity.

With the invention according to the procedure, the hydrophilic areas on a plate may be kept very small and positioned very precisely, so that the surface density of the test volumes may be significantly reduced compared to microtitre plates according to prior art.

The invention will be further described with the examples, which do not, however, represent a restriction of the invention.

### EXAMPLE 1

To coat a plate made of aluminium, first an epoxy-functional resin (KBD7142) was produced. For this a mixture of

30 g glycidyl methacrylate

70 g PFMA ([C9F19CH2CH20-CO-C(CH3)=CH2])

1 g AIBN (azobisisobutyronitrile)

100 g MIBK (methylisobutylketone)

was dripped into a flask over a period of 2 h at 90° and stirred for 16 h. Then 50 g of 1,1,2-trichlorotrifluoroethane was added.

Then, the KBD 7142 was dissolved 1:50 in MIBK (methylisobutylketone 100 ml) and 1 g of fine-particle SiO₂ of the type Aerosil R 812 (manufacturer Degussa, Hanau) added.

A 150×150 mm² substrate made of aluminium was sprayed with this solution.

The layer thickness was 50 μm. Then, the plate was allowed to flash off for 12 h at room temperature.

The contact angle of a water droplet lying on this surface was 174°, the roll-off angle of a water droplet with a volume of 10 μl was <5°.

The ulltrahydrophobic coating of the Al test plate was then partially stripped by means of laser ablation in order to use the test plate as a microtitre plate.

For this, a beam from an eximer laser focused by a lens with a focal length of f=100 mm at a wavelength of 248 nm with a surface power density of 0.5 J/cm⁻² was used.

In the plate, 64×64=4096 areas with a size of 20×20 μm² at distances of 2 mm each on a overall area of 126×126 mm² were irradiated with the laser. Then, water droplets with a volume of 500 nl were positioned on each on the irradiated areas by means of a pipette. The diameter of the water droplet was approximately 1 mm. The positioning of the droplets was performed by means of an automatic metering device with automated xy positioning. The droplets were fixed in a vibrationally stable manner to the hydrophilic areas and functioned as microtitre plate sample volumes for the performance of sample reactions. There was no side boundary to the volumes in the form of container walls since the spherical curvature held the droplets stable. The small hydrophilic defect in the surface (5×5 μm²) fixed the droplet to the desired position.

The droplets were used, for example, to perform a colour reaction. The colour reaction may either be read out qualitatively (e.g. colour change) or it is also possible to perform a quantitative concentration determination by means of an absorption measurement as in conventional test plates.

1. Surface structure, in particular a plate, particularly preferably microtitre plate, with a surface with ultraphobic properties, characterised in that the surface structure is structured with a plurality of hydrophilic areas which are enclosed by ultraphobic areas.

2. Surface structure according to claim 1, characterised in that the hydrophilic areas are partially or completely distributed on the surface in a periodic manner.

3. Surface structure according to claim 2, characterised in that the hydrophilic areas distributed on the surface in a periodic manner have the same surface shape.

4. Surface structure according to claim 3, characterised in that the surface shape of the individual hydrophilic areas is rectangular or circular.

5. Surface structure according to one of claims 1 to 4, characterised in that the surface area of the individual hydrophilic areas is from 1 nm² to 1 μm².

6. Surface structure according to claim 1, characterised in that the hydrophilic areas are partially or completely distributed on the surface in such a way that they form an image and/or character pattern.

7. Surface structure according to one of claims 1 to 6, characterised in that it is a film which is preferably disposed of after use.

8. Use of the surface structure according to one of claims 1 to 7 as a printing plate in particular for black-white printing or multi-colour printing.

9. Use of the surface structure according to one of claims 1 to 7 as a microtitre plate.

10. Procedure for the production of a surface structure according to one of claims 1 to 7 by the selective removal of an ultraphobic surface layer on a hydrophilic substrate at the places which form hydrophilic areas, in particular by mechanical or chemical stripping, irradiation and possibly ablation of the surface, in particular by means of laser radiation of a suitable intensity.
